(19) United States
(12) Patent Application Publication
(10) Pub. No.: US 2007/0229715 A1
(43) Pub. Date: Oct. 4, 2007

(54) METHOD AND SYSTEM OF MANUALLY SETTING CHANNELS

(75) Inventor: Chih-Cheng Chang, Keelung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/561,350

(22) Filed: Nov. 17, 2006

(30) Foreign Application Priority Data
Mar. 28, 2006 (TW) TW95110682

(51) Int. Cl. H04N 5/50

(52) U.S. Cl. 348/731; 348/732

(57) ABSTRACT

A method of manually setting a channel within a frequency range. The method comprises the following steps. A start frequency and a surf direction are set, and then surf channels. When a target channel is found or a pause instruction is received, surfing pauses. An auto naming function is executed to obtain a channel name of the target channel. A user determines whether to keep the channel name in a channel list. Surfing is repeated until the entire frequency range is searched or a stop instruction is received.

### BACKGROUND OF THE INVENTION

### Field of the Invention

The invention relates to surfing channels within a frequency range and, more particularly, to setting a certain TV channel within a frequency range.

Typical televisions have pre-installed channel setting systems for surfing television channels within a frequency range. When a television is first initialized, a user may command a tuner in the television to search television channels. A channel list constitutes those television channels that are tuned to when the user presses the channel up or the channel down buttons on a remote control device. The frequencies of television channels are also recorded in the channel list. The next time the television is turned on, the user does not have to re-surf the entire frequency range to know which frequency carries which television channel, but simple allows the television to check the channel list.

Typical channel setting up systems have some drawbacks. When there is no television channel in the television frequency range, typical channel setting systems do not automatically stop searching. The television would continually stay in a searching status. Some channel setting systems always find the same television channel and always skip certain channels.

### BRIEF SUMMARY OF THE INVENTION

In one aspect of the invention, a method of manually setting a channel within a frequency range is provided. The method comprises the following steps. A start frequency and a surf direction are set, and then surf channels. When a target channel is found or a pause instruction is received, surfing pauses. All auto naming function is executed to obtain a channel name of the target channel. A user determines whether to keep the channel name in a channel list. Surfing is repeated until the entire frequency range is searched or a stop instruction is received.

In another aspect of the invention, a system for manually setting channels within a frequency range is provided. The frequency range is between a first frequency and a second frequency. The system comprises a tuner, a user interface, a storage unit, and a processing unit. The user interface may receive a pause searching instruction, a store instruction, or a surf direction. The tuner searches the target channel according to the surf direction from a starting frequency, and pauses searching when the tuner finds the target channel or the user interface receives the pause searching instruction. The target channel is a channel with a signal comprising channel information. The storage unit stores a channel list. The processing unit is coupled to the tuner. The processing unit executes an auto naming function to obtain a channel name of the target channel. When the user interface receives the store instruction, the processing unit keeps the frequency and channel name of the target channel in the channel list.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows a block diagram of a system for manually setting channels according to an embodiment of the invention; and

FIG. 2 shows a flowchart of manually setting channels according to an embodiment of the invention.

### DETAILED DESCRIPTION OF THE INVENTION

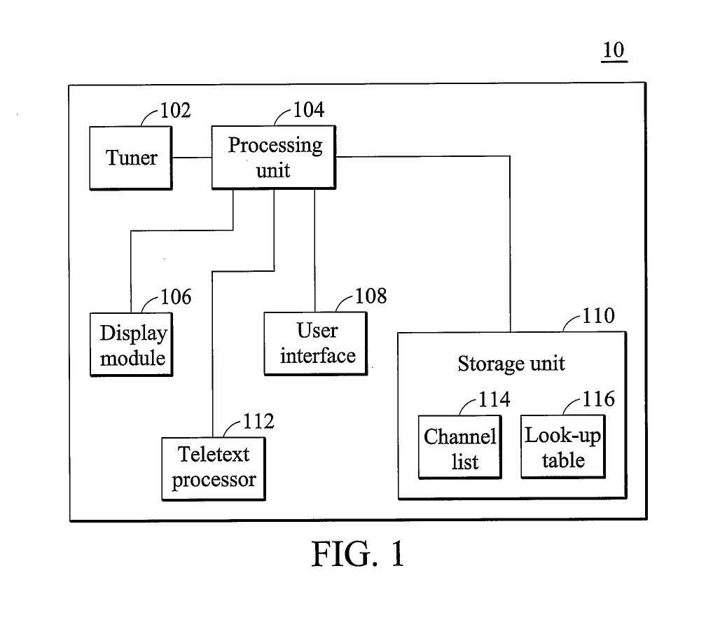

FIG. 1 shows a block diagram of a system for manually setting channels according to an embodiment of the invention. In one embodiment of the invention, the system can be applied to a television or a radio player. The system of manually setting channels comprises a tuner 102, a processing unit 104, a display module 106, a user interface 108, a storage unit 110 and a teletext processor 112. The tuner 102 searches for a target channel within a frequency range. In this embodiment of the invention, the frequency range is between a first frequency 41MHz and a second frequency 866.25MHz. A target channel is a channel with a signal comprising channel information, such as a channel code. The storage unit 110 maintains a channel list 114. When the processing unit 104 finds a channel signal of the target channel, the frequency of the target channel is kept in the channel list 114. The teletext processor 112 can extract a Country Network code, (CNI code) of the target channel from the channel signal which is searched. The storage unit 110 further stores a look-up table 116 recording the relationship of the CNI codes and the channel names. The processing unit 104 retrieves the channel name based on the CNI code of the channel signal in channel list 114. The user interface 108 receives a store instruction, a searching order, or a pause searching instruction. The processing unit 104 can determine the surf direction of the tuner 102 according to aforementioned searching order. The surf direction can be determined by whether the user presses the channel up (i.e. channel +) or the channel down (i.e. channel −) buttons or keys on a remote control device. The surfing direction can be from low frequency to high frequency or from high frequency to low frequency. The user interface 108 may be a remote control, and a receiver coupled to the processing unit 104. When a user presses the direction button of the remote control, the receiver can pass the instruction to the processing unit 104.

When processing unit 104 determines that the tuner 102 has found the target channel, the tuner 102 stops searching. The processing unit 104 executes an auto naming function to obtain the channel name of the target channel. Moreover, when the user interface 108 receives the store instruction, the processing unit 104 stores the channel name and the frequency of the target channel into the channel list 114 of the storage unit 110. The display module 106 further displays the channel name of the target channel.

Table 1 shows an example of the look-up table 116. In this embodiment of the invention, the look-up table has two columns, one column is CNI code, and the other is channel name. The CNI code is a unique code, which means different CNI codes indicate different channels, and different channels have different CNI codes.

TABLE 1
An example of the look-up table 116

| CNI code | channel name |
|---|---|
| 0x0A0xC1 | HBO |
| 0x0A0xC2 | CNN |
| . . . | . . . |
| 0x0D0xC1 | BBC |

Table 2 shows an example of the channel list. In this embodiment of the invention, the channel list has two columns. One column contains CNI codes, and the other contains the frequencies corresponding to the CNI codes. This channel list contains the frequencies on which there is channel signal within the frequency range for channel surfing. The frequency range is between a first channel 41 MHz and the second frequency 866.25 MHz. In another embodiment of the invention, the column of CNI codes can be replaced by channel names.

TABLE 2
An example of the channel list

| CNI code | frequency |
|---|---|
| 0x0A0xC1 | 80 MHz |
| 0x0A0xC2 | 85 MHz |
| . . . | . . . |
| 0x0D0xC1 | 100 MHz |

Another condition for the tuner 102 to stop searching is when the user interface 108 receives a pause searching instruction. Sometimes the channel signal is barely watchable, but the channel signal is so weak that the channel information can not be recognized by the teletext processor 112. The tuner 102 may slip the channel signal. A user can send the pause searching instruction to keep the channel in the channel list 114.

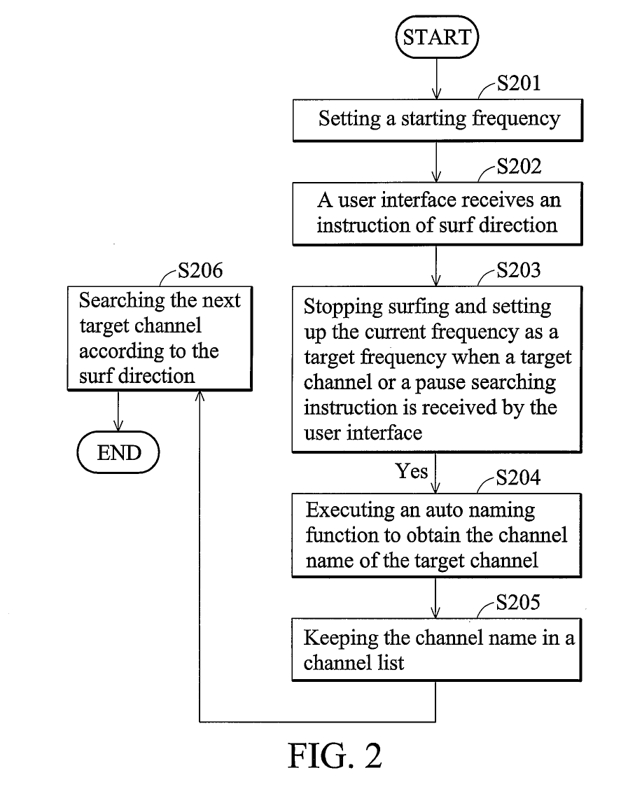

FIG. 2 shows a flowchart of manually setting channels according to an embodiment of the invention. The method is used to surf within a frequency range and find a target channel. The frequency range is between a first frequency and a second frequency, and the target channel is a channel with a signal comprising channel information. The channel information may be the CNI code of the channel. First, a starting frequency is set, in step S201. A surf direction instruction is received by a user interface in step S202. The instruction is for deciding the searching direction. When a target channel is searched or a pause searching instruction is received by the user interface, a turner stops surfing and sets up the current frequency as a target frequency in step S203, wherein the target frequency is the frequency of a target channel. In step S204, an auto naming function is executed to obtain the channel name of the target channel by using the CNI code as in index to search a look-up table. The target frequency and the channel name are kept in a channel list in step S205. Step S206 searches for the next target channel according to the surf direction.

For example, suppose the target channels existing in the frequency range are those shown in Tables 1 and 2. When the user interface 108 receives a searching order of “up”, the tuner 102 starts with a starting frequency 110 MHz toward a second frequency 866.25 MHz. The starting frequency in this embodiment is set for easy illustration. In other embodiments of the invention, the starting frequency can be adjusted through user interface 108. Since there are no target frequencies between starting frequency 110 MHz and the second frequency 866.26 MHz, the tuner 102 then searches the target channels from the first channel 41 MHz toward the starting frequency 110 MHz. When the tuner 102 searches the frequency near 80 MHz, the teletext processor 112 can successfully extract the CNI code 0x0A0xC1 of the target channel, and the tuner 102 stops searching. In this embodiment of the invention, the first frequency is defined to be the lower boundary of the frequency range, and the second frequency is defined to be the upper boundary of the frequency range. In other embodiments of the invention, the first frequency can be the upper boundary of the frequency range, and the second frequency can be the lower boundary of the frequency range.

In an embodiment of the invention, the frequency range can be circularly surfed. For example, in a given frequency range from 41 MHz to 866.25 MHz, the first frequency can be the upper boundary of the frequency range, i.e., 866.25 MHz, and the second frequency can be the lower boundary of the frequency range, which is 41 MHz. The tuner searches from the starting frequency toward the 866.25 MHz, and when the tuner reaches to the 866.25 MHz without finding the target channel, the tuner further searches from 41 MHz toward the starting frequency. In short, by the searching method of the embodiment, the frequency range can be fully searched.

In another embodiment of the invention, the frequency range is “two-stage” searched. For example, the tuner searches from the starting frequency to the first frequency. If the target channel is not found, then the tuner searches from the starting frequency toward the second frequency. The first frequency can be the lower bound of the frequency range, and the second frequency can be the upper bound of the frequency range. In other embodiments of the invention, the first frequency can be the upper bound of the frequency range, and the second frequency can be the lower bound of the frequency range.

A method for manual channel setting and a system thereof is provided. The difference between auto setting channel and manually setting channel lies in, when the auto setting channel function is activated, all channels in frequency range will be found, while the manually channel setting function only searches upward or downward for another channel, and the user can decides whether or not to keep the found channel. Suppose a television station is newly built, and television programs are being broadcasted. The user may want to update the information record in the channel list. When the user executes an auto setting channel function, the tuner will search the entire frequency range, which takes a few minutes. A user, however, can manually execute channel setting function around the new channel to update the channel list, in much less time than auto channel setting function requires.

For example, referring Table 1 and Table 2, suppose a user is watching a channel with frequency at 80 MHz and having a channel name of “HBO”. When the user wants to set another channel, the user sends a search channel upward instruction. When the tuner searches to 85 MHz, the teletext processor can extract the CNI code 0x0A0xC2 within the channel signal. The tuner locks in the channel, and stops searching. The channel name of the current channel, CNN, can be obtained by checking the look-up table (Table 1). The frequency of the current channel is recorded in the channel list (Table 2). In the embodiment of the invention, the tuner searches for a channel signal and then stops searching. In other embodiment of the invention, when the user interface receives a pause searching instruction command by a user, the searching of the tuner pauses as well. When the tuner can not successfully determine if a frequency carries a channel signal and thus the tuner skips the frequency, the user may command a pause searching instruction to manually set the channel. The channel name of a channel set manually upon the user's pause searching instruction can also be extracted from the look-up table as described in step S203 and S204.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of manually setting channels within a frequency range, wherein the frequency range is between a first frequency and a second frequency, the method comprising:
(A) providing a starting frequency and a surf direction, and searching for a target channel according to the surf direction, wherein the target channel is a channel with a signal comprising channel information;
(B) recording a current frequency as a target frequency when finding the target channel or receiving a pause searching instruction;
(C) executing an auto naming function to obtain a channel name of the target channel;
(D) determining whether to record the channel name and the target frequency in a channel list; and
(E) continuing to surf according to the surf direction, and returning to step (B).

2. The method as claimed in claim 1, wherein the surf direction in step (A) is surfing from the starting frequency toward to the first frequency, and when reaching to the first frequency, surfing from the second frequency toward the starting frequency.

3. The method as claimed in claim 1 further comprising stopping searching for the target channel upon reaching the starting frequency.

4. The method as claimed in claim 1, wherein the surf direction in step (A) is a direction from the starting frequency toward the first frequency, and when reaching to the first frequency, surfing from the starting frequency toward the second frequency.

5. The method as claimed in claim 4 further comprising stopping searching the target channel upon reaching the second frequency.

6. The method as claimed in claim 1, wherein the first and second frequencies are adjustable.

7. The method as claimed in claim 1, between step (C) and step (D), further comprising:
(C-1) displaying the channel name of the target channel.

8. The method as claimed in claim 1, wherein the target channel is a television channel.

9. The method as claimed in claim 1, wherein the channel information comprises a channel code and the auto naming function of the step (C) comprises:
obtaining the channel code from the channel information of the target channel; and
retrieving the channel name from a table, wherein the table comprises the channel code and the channel name corresponded to the channel code.

10. The method as claimed in claim 1 further comprising stopping searching channel when receiving a stopping searching instruction during executing step (A) to step (E).

11. A system for manually setting channels within a frequency range, wherein the frequency range is between a first frequency and a second frequency, and the system comprises:
a user interface receiving a pause searching instruction, a store instruction, and a surf direction;
a tuner searching for a target channel according to the surf direction from a starting frequency, and pausing searching when the target channel is found at a target frequency or the user interface receives the pause searching instruction, wherein the target channel is a channel with a signal comprising channel information;
a storage unit storing a channel list; and
a processing unit coupled to the tuner, the user interface and the storage unit, executing an auto naming function to obtain a channel name of the target channel, and when the user interface receives the store instruction, storing the target frequency and channel name of the target channel into the channel list.

12. The system as claimed in claim 11 further comprising a display module displaying the channel name of the target channel obtained by the processing unit.

13. The system as claimed in claim 11, wherein the storage unit further comprises a look-up table, the look-up table comprises a channel code and the channel name corresponding to the channel code, and the system further comprises a teletext processing unit to obtain the channel code from the channel information; when the auto naming function is executed, the processing unit searches the look-up table in the storage unit by the channel code to obtain the channel name of the target channel.

14. The system as claimed in claim 13, wherein the channel code is a Country Network (CNI) code.

15. The system as claimed in claim 11, wherein the surf direction is surfing from the starting frequency toward the first frequency, and upon reaching the first frequency, surfing from the second frequency toward the starting frequency.

16. The system as claimed in claim 15, wherein the tuner stops searching the target channel when the tuner searches to the starting frequency.

17. The system as claimed in claim 11, wherein the surf direction is searching from the starting frequency toward the first frequency, and upon reaching the first frequency, searching form the starting frequency toward the second frequency.

18. The system as claimed in claim 17, wherein the tuner stops searching the target channel when the tuner searches to the second frequency.

19. The system as claimed in claim 11, wherein the user interface receives a pause searching instruction, and when the user interface receives the pause searching instruction, the tuner stops searching.

20. The system as claimed in claim 11, wherein the first frequency and the second frequency can be adjusted via the user interface.
